(19) United States
(12) Patent Application Publication
(10) Pub. No.: US 2015/0292970 A1
(43) Pub. Date: Oct. 15, 2015

(54) PRESSURE SENSOR AND METHOD OF MANUFACTURING THE SAME

(71) Applicant: KABUSHIKI KAISHA TOSHIBA, Tokyo (JP)

(72) Inventors: Ryunosuke GANDO, Yokohama Kanagawa (JP); Daiki ONO, Yokohama Kanagawa (JP); Naofumi NAKAMURA, Tokyo (JP); Yumi HAYASHI, Zama Kanagawa (JP)

(73) Assignee: KABUSHIKI KAISHA TOSHIBA, Tokyo (JP)

(21) Appl. No.: 14/636,998

(22) Filed: Mar. 3, 2015

(30) Foreign Application Priority Data
Apr. 10, 2014 (JP) 2014-081058

(51) Int. Cl. G01L 9/00

(52) U.S. Cl. CPC G01L 9/0072

(57) ABSTRACT

According to one embodiment, a pressure sensor includes a fixed electrode fixed on a substrate, a movable electrode provided above the fixed electrode, so as to be movable in vertical directions, a thin-film structure of a dome shape, forming, together with the substrate, a cavity to accommodate the fixed electrode and the movable electrode, the thin-film structure includes a communicating hole to communicate the cavity with an outside of the thin-film structure. A voltage is applied between the fixed electrode and the movable electrode to measure mechanical displacement of the movable electrode.

### CROSS-REFERENCE TO RELATED APPLICATIONS

This application is based upon and claims the benefit of priority from Japanese Patent Application No. 2014-081058, filed Apr. 10, 2014, the entire contents of which are incorporated herein by reference.

### FIELD

Embodiments described herein relate generally to a pressure sensor which employs a MEMS device and a method of manufacturing the same.

### BACKGROUND

A pressure sensor employing a MEMS device comprises a movable electrode and a fixed electrode in an airtightly sealed dome. In accordance with the change in external pressure, the dome and the variable electrode displace, and thus the capacitance between the movable electrode and the fixed electrode changes. It is possible to measure pressure by detecting the change in capacitance. But the conventional techniques entail such a drawback that it is difficult in some external pressure regions to detect pressure with high sensitivity.

### BRIEF DESCRIPTION OF THE DRAWING

FIG. 1 is a cross-sectional diagram briefly showing the structure of a pressure sensor according to the first embodiment;

FIG. 2 is a plan view illustrating an opening of a dome of the pressure sensor shown in FIG. 1;

FIGS. 3A and 3B are schematic diagrams showing the relationship between a direct-current voltage applied between a fixed electrode and a movable electrode of the pressure sensor shown in FIG. 1, and the displacement of the variable electrode;

FIG. 4 is a characteristic diagram showing oscillation characteristics of the movable electrode in the pressure sensor shown in FIG. 1;

FIG. 5 is a diagram showing an example of a Q-value measuring circuit of the pressure sensor shown in FIG. 1;

FIG. 6 is a schematic diagram showing the relationship between an applied frequency and the displacement of the variable electrode when a high frequency voltage is applied to the pressure sensor shown in FIG. 1;

FIG. 7 is a cross-sectional diagram briefly showing the structure of a pressure sensor according to the second embodiment;

FIG. 8 is a plan view illustrating an opening of a dome of the pressure sensor shown in FIG. 7;

FIGS. 9A to 9H are cross-sectional diagrams illustrating steps of manufacturing the pressure sensor shown in FIG. 7; and

FIG. 10 is a schematic diagram showing the relationship between an atmospheric pressure and the capacitance or Q-value in the pressure sensor shown in FIG. 7.

### DETAILED DESCRIPTION

In general, according to one embodiment, a pressure sensor comprises: a fixed electrode fixed on a substrate; a movable electrode provided above the fixed electrode, the movable electrode being movable in vertical directions; and a thin-film structure of a dome shape, forming, together with the substrate, a cavity to accommodate the fixed electrode and the movable electrode, the thin-film structure comprising a communicating hole to communicate the cavity with an outside of the thin-film structure.

MEMS pressure sensors of the following embodiments may be used for, for example, pressure sensors for smartphones (when used as an altimeter, activity meter, etc.), those for healthcare purpose, those of vehicle-mounted types (lateral collision sensor, tire pressure monitoring system [TPMS], etc.) and the like.

### First Embodiment

This embodiment provides a pressure sensor capable of sensing a low-pressure region with high sensitivity.

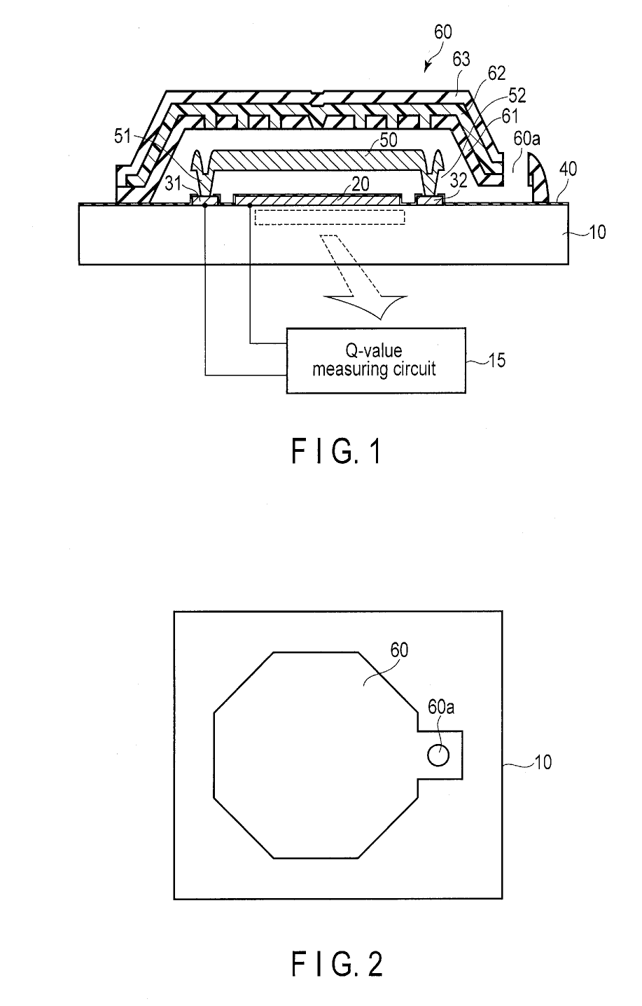

FIG. 1 is a cross-sectional diagram briefly showing the structure of a pressure sensor according to the first embodiment.

For example, a planar fixed electrode (lower electrode) 20 and interconnect wires 31 and 32 are provided on a substrate 10 of Si or the like. The planar pattern of the fixed electrode 20 is basically polygonal (octagonal). The interconnect wires 31 and 32 are provided on outer sides of the fixed electrode 20. Examples of the material of the fixed electrode 20 and the interconnect wires 31 and 32 are Al and AlCu alloy. The fixed electrode 20 and the interconnect wires 31 and 32 are covered by an SiN film 40 but openings are made in the SiN film 40 at sections on the interconnect wires 31 and 32.

A planar movable electrode (upper electrode) 50 is provided above the fixed electrode 20 such as to be movable in vertical directions. The planar pattern of the movable electrode 50 is basically similar to that of the fixed electrode 20, that is, polygonal (octagon in this case), and the movable electrode 50 is placed to oppose the fixed electrode 20. End portions of the movable electrode 50 are connected to the interconnect wires 31 and 32 respectively via spring members 51 and 52.

Examples of the material of the movable electrode 50 and the spring members 51 and 52 are Al and AlCu alloy.

The spring members 51 and 52 are formed integrally with the movable electrode 50 as one unit, but thinner than the thickness of a flat surface portion of the movable electrode 50. Further, the portions where the spring members are provided are not limited to the two sections opposing the movable electrode 50, but there may be two more locations rotated by 90 degrees with respect to the center of the movable electrode 50, a total of four spring members at four sections.

A thin-film dome 60 having a laminated structure is provided on the substrate 10 such as to form a cavity to accommodate the fixed electrode 20, the interconnect wires 31 and 32 and the movable electrode 50. The thin-film dome 60 has a laminated structure comprising a first insulating film 61 of SiO, SiN or the like, an organic resin film 62 of polyimide or the like, and a second insulating film 63 of SiO, SiN or the like. The thin-film dome need not necessarily make to a complete dome, and is good as the shin-film structure body of a dome shape.

A part of the thin-film dome 60 is provided to project outward as shown in FIG. 2. The projecting section has a through-hole (connection hole) 60a made through the thin-film dome 60 vertically, and the inside of the dome of the MEMS device is opened. In other words, the inside of the dome of the MEMS device is communicated to the atmosphere or outside air of the device.

A Q-value measuring circuit 15 is connected between the fixed electrode 20 and the interconnect wires 31 and 32 such as to measure the mechanical characteristics of the movable electrode 50. The Q-value measuring circuit 15 is formed as a CMOS consolidated circuit in the substrate 10. The Q-value measuring circuit 15 is configured, for example, to apply a voltage between the fixed electrode 20 and the movable electrode 50, and measure the time characteristics or frequency characteristics in displacement.

Next, the principle of the pressure measurement using the pressure sensor of this embodiment will now be explained.

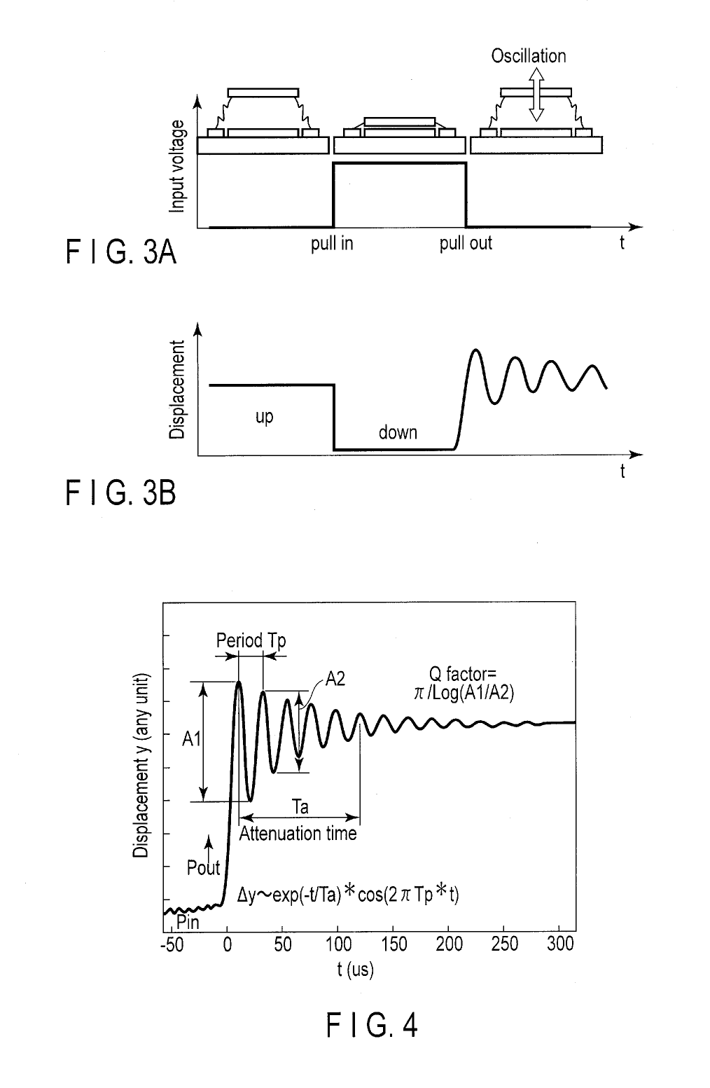

FIG. 3A shows a voltage input of the movable electrode and FIG. 3B shows a displacement of the movable electrode. When a DC voltage is not applied between the fixed electrode 20 and the movable electrode 50, the movable electrode 50 is separated from the fixed electrode 20 (an up state). When a DC voltage is applied (pulled in) between the fixed electrode 20 and the movable electrode 50, the movable electrode 50 is attracted towards the fixed electrode 20 and contact thereto (a down state). From this state, when the voltage application is stopped (or pulled out), the movable electrode 50 is separated from the fixed electrode 20.

Since, here, the movable electrode 50 is connected to the interconnect wires 31 and 32 via the spring members 51 and 52, respectively, the movable electrode 50 oscillates for a certain period of time. This oscillation time varies depending on the pressure of the circumstance in which the movable electrode 50 is located, that is, the pressure in the surrounding area of the sensor. In other words, the air pressure serves as a resistance, and therefore as the air pressure is lower, the oscillation (Q-value) increases. Therefore, it is possible to measure the pressure in the surrounding area of the sensor by measuring the above-described oscillation characteristics. (See Sensor and Actuators A48 (1995) 239-248, “Equivalent-circuit model of the squeezed gas film in a silicon accelerometer”.)

FIG. 4 is a diagram showing oscillation characteristics of the movable electrode 50 in more detail. The Q-value is expressed as:

Q=n/log(A1/A2)

where the first peak of oscillation is A1 and the peak at a certain time Tp in the first cycle from the first peak is A2. The Q-value changes greatly in a low-pressure region of 0.1 to 10 kPa, in particular, this embodiment is effectively utilized for the measurement of a low-pressure region.

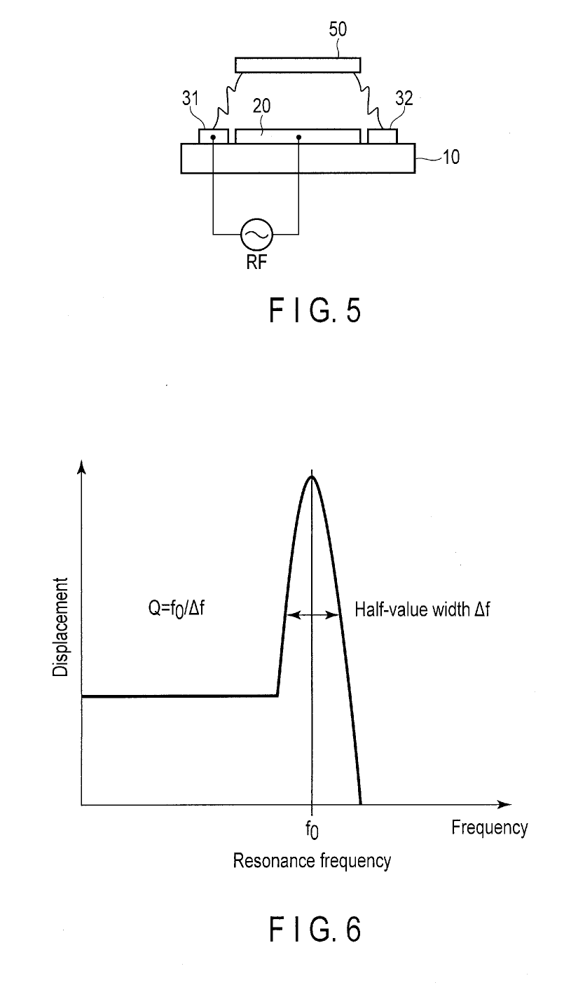

In the meantime, as shown in FIG. 5, for example, a high-frequency voltage near the resonant frequency is applied between the fixed electrode 20 and the movable electrode 50. When the high-frequency voltage is applied, the movable electrode 50 has a peak in displacement at a resonant frequency as shown in FIG. 6. This peak value varies depending on the pressure in the surrounding area of the movable electrode 50. In other words, the sharpness (Q-value) of peaks decreases as the atmospheric pressure increases. Consequently, it is possible to measure the pressure by measuring the peak value.

Specifically, the Q-value can be calculated by

Q=f₀/Δf

Where f₀ represents resonant frequency and Δf represents a half-value width. Here, the change in Q-value is large in a low-pressure region of 0.1 to 10 kPa, in particular, this embodiment is effectively utilized for the measurement of a low-pressure region.

According to this embodiment, the through-hole 60a is made through the thin-film dome 60 of the MEMS device. With this structure, it is possible to measure the mechanical characteristics of the movable electrode 50 while the inside of the thin-film dome 60 communicating to the outside air. In this manner, a low pressure region can be sensed with high sensitivity.

Further, in this case, the through-hole 60a is made in an outer side of the portion above the movable electrode, and therefore it is possible to inhibit contaminants, foreign matters and dusts entering from the through-hole 60a from attaching to the movable electrode 50. Further, when a portion of the dome is formed to project outside, and the through-hole 60a is made in the projecting portion, the size of the dome is not increased for the following reasons.

That is, due to the problem of the invasion of contaminants, it is not desirable that the through-hole 60a be made above the movable electrode 50. Further, it is also difficult to form the through-hole 60a in an inclined side surface of the thin-film dome 60. Here, if the flat portion of the thin-film dome 60 is made larger than the movable electrode 50, the size of the dome is increased. By contrast, when the flat portion of the thin-film dome 60 is made substantially equal in size to the movable electrode 50 and a portion of the thin-film dome 60 is made to project outwards, the through-hole 60a can be made easily in an outer side of the portion above the movable electrode 50 without causing the increase in the size of the thin-film dome 60.

Further, according to this embodiment, a CMOS consolidated circuit is provided on the substrate 10 in which the MEMS device is formed. With this structure, the following advantage can be further achieved. That is, the interconnect wires to connect between the MEMS device and measurement circuits can be made shortest, and thus the parasitic capacitance can be made minimized, which makes it possible to improve the sensitivity in pressure measurement. Further, the CMOS consolidated circuit is provided on the underlying substrate of the MEMS element, which enables a wafer-level package structure, and therefore a further size reduction can be achieved.

In the meantime, the Q-value of the resonator (the movable electrode 50) depends on the surrounding temperature, besides the surrounding pressure. (See Journal of Microelectromechanical Systems, Vol. 17, No. 3, June 2008 755-766, “Temperature Dependence of Quality Factor in MEMS Resonators”.)

There is a relationship expressed by the equation: Q=constant×(√temperature/pressure). Therefore, when the Q-value of a resonator is used as a measurement object of a pressure sensor, it is necessary to detect the surrounding temperature of the resonator for correction, in order to improve the accuracy of the pressure measurement and widen the temperature range in which the device can be operated. When the CMOS consolidated circuit is provided directly underneath the resonator as in this embodiment, it is possible to easily detect the temperature of the nearby area of the MEMS device for correction.

Further, the thin-film dome 60 has a three-layer structure, which exhibit the following advantage. That is, in the normal etching operation, a washing process is provided after the etching. If this operation is applied to this embodiment and the washing process is carried out, washing liquid and residue after etching enter the thin-film dome 60, which becomes a factor for hindering the movement of the movable electrode 50. However, it is not desirable to omit the washing process after etching.

As compared to the above, when the thin-film dome 60 has the three-layer structure as in this embodiment, it suffices if the washing process is carried out after etching up to the polyimide film 62, and thereafter the SiO film 61 is etched. In this case, when washing is carried out in advance before opening the through-hole 60a, the washing process to be carried out after etching the undermost layer, SiO film 61 may be omitted without any substantial problem.

Furthermore, according to this embodiment, the spring members 51 and 52 are formed integrally with the movable electrode 50 as one unit. With this structure, the durability can be improved in comparison with the case where separate spring members are jointed to the movable electrode 50. This structure is effective particularly when the movable electrode 50 is oscillated.

### Second Embodiment

According to this embodiment, a pressure sensor is provided which can sense a wide pressure range including a low-pressure region with high sensitivity.

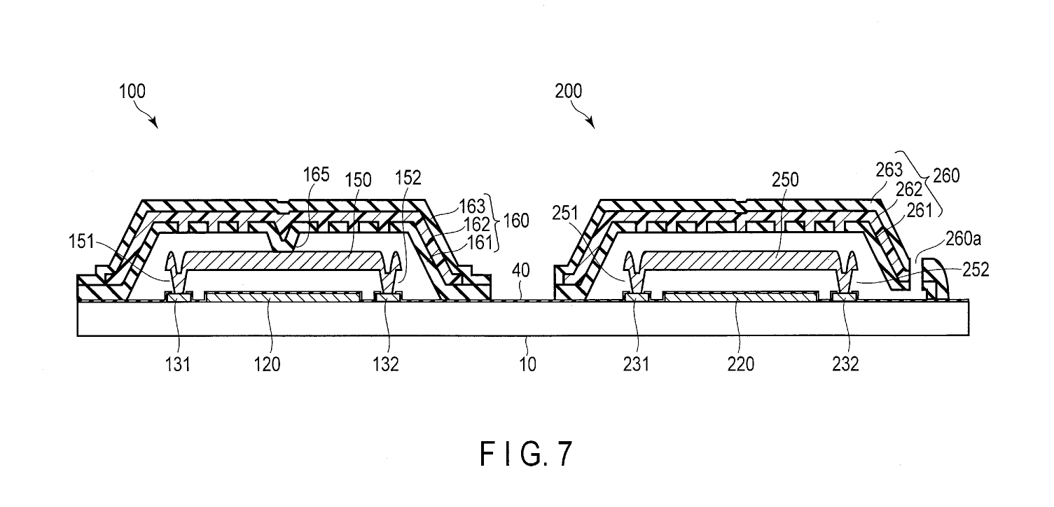

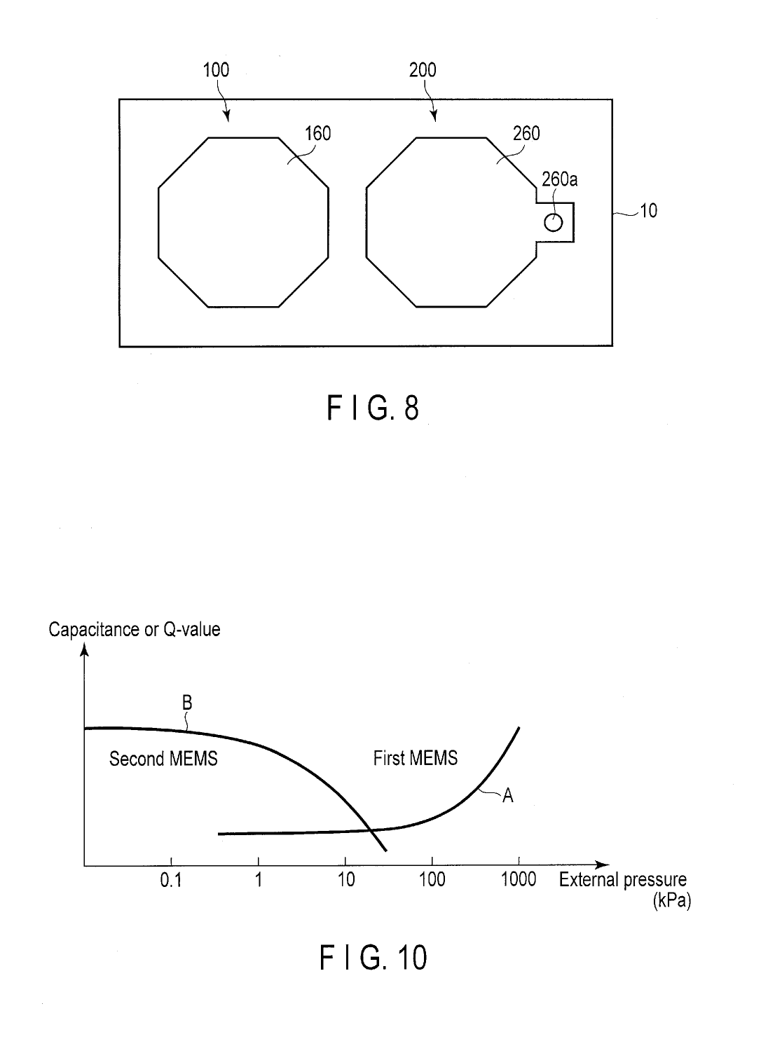

FIG. 7 is a cross-sectional diagram briefly showing the structure of a pressure sensor according to the second embodiment. FIG. 8 is a plan view illustrating an example of arrangement of first and second MEMS devices of the sensor.

A first MEMS element 100 for high-pressure range measurement and a second MEMS element 200 for low-pressure range measurement are arranged adjacent to each other on a substrate 10 of Si or the like.

The first MEMS element 100 has the following structure.

That is, for example, a first planar fixed electrode (lower electrode) 120 and first interconnect wires 131 and 132 are provided on the substrate 10 of Si or the like. The planar pattern of the fixed electrode 120 is basically polygonal (octagon). The interconnect wires 131 and 132 are provided on outer sides of the fixed electrode 120. Examples of the material of the fixed electrode 120 and the interconnect wires 131 and 132 are Al and AlCu alloy. The fixed electrode 120 and the interconnect wires 131 and 132 are covered by an SiN film 40 but openings are made in the SiN film 40 at sections on the interconnect wires 131 and 132.

A planar first movable electrode (upper electrode) 150 is provided above the fixed electrode 120 such as to be movable in vertical directions. The planar pattern of the movable electrode 150 is basically similar to that of the fixed electrode 120, that is, polygonal (octagon in this case), and the movable electrode 150 is placed to oppose the fixed electrode 120. End portions of the movable electrode 150 are connected to the interconnect wires 131 and 132 respectively via first spring members 151 and 152.

Examples of the material of the movable electrode 150 and the spring members 151 and 152 are Al and AlCu alloy. The spring members 151 and 152 are formed integrally with the movable electrode 150 as one unit, but thinner than the thickness of a flat surface portion of the movable electrode 150. Further, the portions where the spring members are provided are not limited to the two sections opposing the movable electrode 150, but there may be two more locations rotated by 90 degrees with respect to the center of the movable electrode 150, a total of four spring members at four sections.

A first thin-film dome 160 having a laminated structure is provided on the substrate 10 such as to form a first cavity to accommodate the fixed electrode 120, the interconnect wires 131 and 132 and the movable electrode 150. The inside of the thin-film dome 160 is airtightly sealed. The thin-film dome 160 has a laminated structure comprising a first insulating film 161 of SiO, SiN or the like, an organic resin film 162 of polyimide or the like, and a second insulating film 163 of SiO, SiN or the like.

An anchor 165 is provided at a central portion of an inner side of the thin-film dome 160. The movable electrode 150 is jointed to the central portion of the inner side of the thin-film dome 160 via the anchor 165. With this structure, the movable electrode 150 is movable in vertical directions together with the thin-film dome 160.

A second MEMS element 200, as in the case of the first MEMS element 100, comprises a second fixed electrode 220, second interconnect wires 231 and 232, a second movable electrode 250 and a second thin-film dome 260, and thus the basic structure thereof is similar to that of the first MEMS element 100. The difference between the second MEMS element 200 and the first MEMS element 100 is that the second MEMS element 200 does not comprise a member equivalent to the anchor 165 and also the second movable electrode 250 is not connected to the second thin-film dome 260 which forms the second cavity.

Further, in the second MEMS element 200, a through-hole (connection hole) 260a is made through the thin-film dome 260, and thus the inside of the dome of the second MEMS device 200 is opened. More specifically, a part of the second thin-film dome 260 is formed to project outward as shown in FIG. 8. The projecting section has a through-hole 260a made through the thin-film dome 260, and the inside of the dome of the second MEMS device 200 is opened. In other words, the inside of the dome of the second MEMS 200 device is communicated to the atmosphere or outside air of the device.

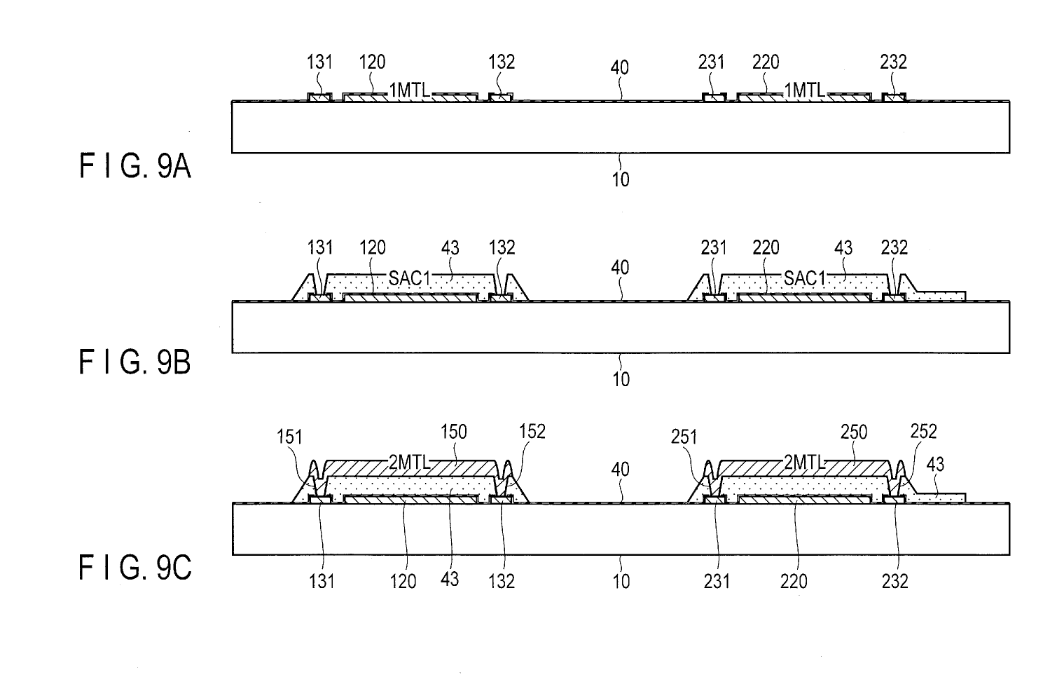

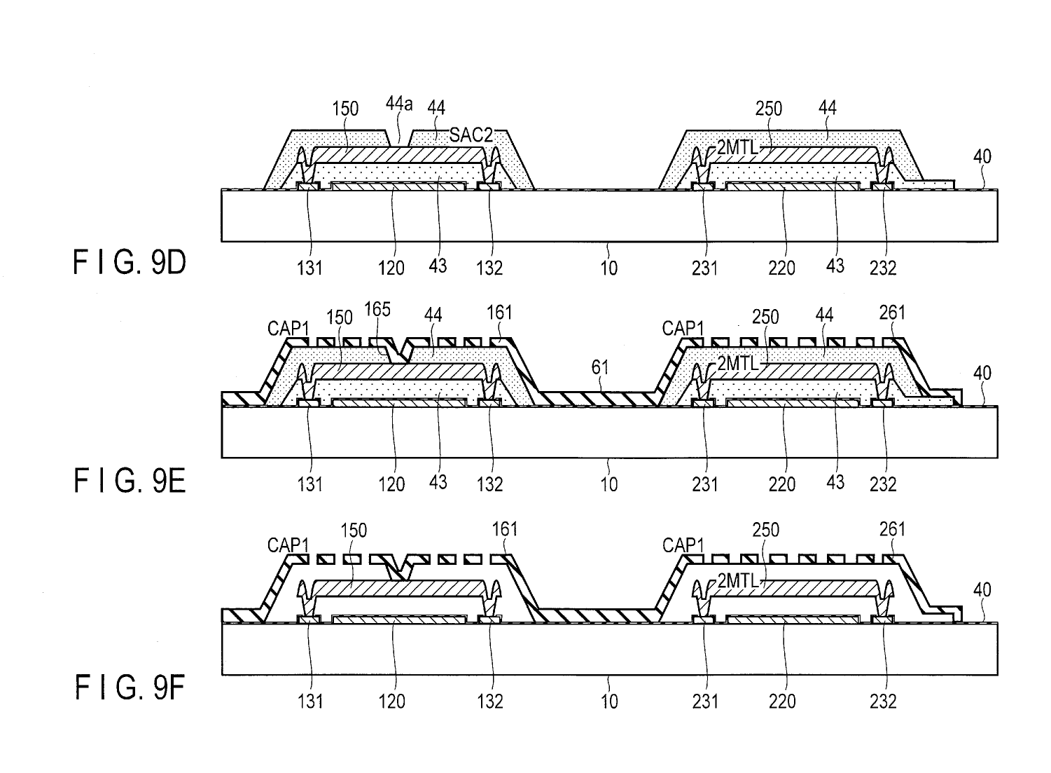

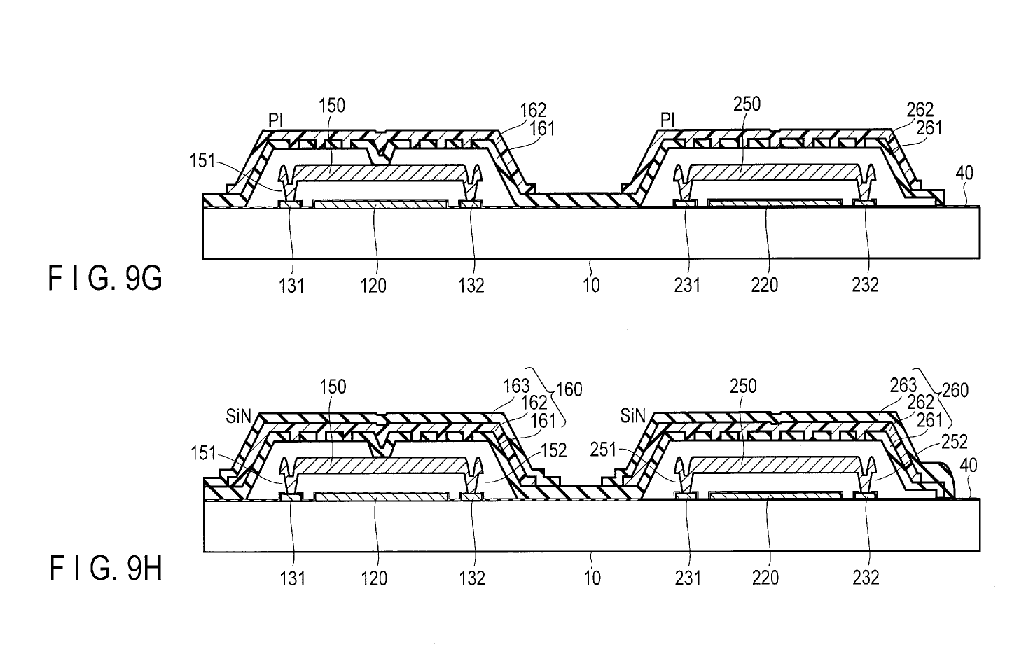

Next, a method of manufacturing the pressure sensor of the present embodiments will now be described with reference to FIGS. 9A to 9H.

Here, the descriptions will be provided in connection with a case where there are at least two

MEMS device regions present on a substrate 10. The steps are common to the two MEMS devices unless otherwise specified.

First, as shown in FIG. 9A, fixed electrodes (1MTL) are formed on the substrate 10 of Si or the like. More specifically, for example, an Al film is formed on an entire surface of the substrate 10 by Al sputtering. Thereafter, by lithography and RIE, a first fixed electrode 120 and first interconnect wires 131 and 132 are formed on a first MEMS device region and a second fixed electrode 220 and second interconnect wires 231 and 232 are formed on a second MEMS device region. Then, by plasma CVD or the like, an SiN film 40 is deposited thereon, followed by lithography and RIE, and thus openings are made in predetermined portions.

Next, as shown in FIG. 9B, first sacrificial layers 43 (SAC1) are formed to cover the fixed electrodes 120 and 220 and the interconnect wires 131, 132, 231 and 232, respectively, in the first and second MEMS device regions. As the sacrificial layers 43, a coating film of an organic resin containing C as a main component, such as polyimide, is used. The thickness of the sacrificial layers 43 is, for example, several hundred nanometers to several micrometers. Subsequently, the sacrificial layers 43 are each patterned into a predetermined shape. Thus, the interconnect wires 131, 132, 231 and 232 are partially exposed.

Next, as shown in FIG. 9C, movable electrodes (2MLT) are formed in the following manner. That is, for example, an Al film is formed on an entire surface by Al sputtering, and after that, by lithography and wet-etching, the Al film is left partially on the first and second MEMS element regions. Thus, the first movable electrode 150 is formed on the first MEMS device region and the second movable electrode 250 is formed on the second MEMS device region.

Here, the Al film portions situated between the flat portion of the movable electrode 150 and the interconnect wires 131 and 132 are formed thin, and these portions function as spring members 151 and 152, respectively. Similarly, the Al film portions situated between the flat portion of the movable electrode 250 and the interconnect wires 231 and 232 are formed thin, and these portions function as spring members 251 and 252, respectively.

Next, as shown in FIG. 9D, second sacrificial layers 44 (SAC2) are formed. The sacrificial layers 44 are formed of the same material as that of the first sacrificial layers 43. Then, the portions except for the first and second MEMS device regions are removed. At the same time, in the first MEMS device region, the sacrificial layer 44 is patterned to have an opening to the movable electrode 150. That is, an opening 44a is formed in a portion where an anchor is to be formed.

Next, as shown in FIG. 9E, an SiO film 61 (CAP1) is deposited, and by lithography and RIE, openings are made in predetermined sections. Here, an SiO film on the first MEMS device region is denoted as 161, and an SiO film on the second MEMS device region is denoted as 261. A portion of the SiO film 161 gives rise to an anchor 165, and the anchor 165 is in contact with an upper surface of the movable electrode 150 in the first MEMS element region.

Note that a polyimide film on the first MEMS device region formed from this step on is denoted as a polyimide film 162, whereas that of the second MEMS device region is denoted as a polyimide film 262. Further, an SiN film on the first MEMS device region is denoted as an SiN film 163, whereas that of the second MEMS device region is denoted as an SiN film 263.

Next, as shown in FIG. 9F, the first and second sacrificial layers 43 and 44 are removed by, for example, O₂ asking through the openings of the SiO films 161 and 261. In this manner, cavities are obtained each as a space in which the movable portion of the respective MEMS device can be operated.

Next, as shown in FIG. 9G, the polyimide films (PI) 162 and 262 are formed on the SiO films 161 and 261, respectively, and also the openings of the SiO films 161 and 261 are blocked with the polyimide films 162 and 262.

Next, as shown in FIG. 9H, the SiN films 163 and 263 are deposited, and then openings are made in predetermined sections thereof (using, for example, lithography and RIE). Thus, the first thin-film dome 160 is formed on the first MEMS device region, and the second thin-film dome 260 is formed on the second MEMS device region. A part of the second thin-film dome 260 projects outwards as shown in FIG. 8.

From this step on, the through-hole 260a is formed in the projecting portion of the second thin-film dome 260 by etching, and thus the structure shown in FIG. 7 is completed. Here, in order to form the through-hole 260a, first, the SiN film 263 is etched by dry-etching, and then the polyimide 262 is etched by wet-etching. Subsequently, the resultant is subjected to washing, and thereafter, the SiO film 261 is etched by dry-etching. When the opening is made through in the final stage, only the lowermost SiO film 261 is etched, and therefore washing can be omitted without any problem.

Next, the pressure measurement principle of the pressure sensor of this embodiment will now be described.

As aforementioned, in the first MEMS device 100, the inside of the thin-film dome 160 is sealed, and the thin-film dome 160 contains the movable electrode 150 and the fixed electrode 120 inside. The thin-film dome 160 and the movable electrode 150 are jointed together, and the thin-film dome 160 and the movable electrode 150 displace according to the difference between the external pressure and internal pressure. On the other hand, in the second MEMS device 200, the inside of the thin-film dome 260 is opened, and therefore the external pressure and internal pressure are equal to each other. The thin-film dome 160 contains the movable electrode 150 and the fixed electrode 120 inside, but the thin-film dome 160 and the movable electrode 150 are not jointed together.

In the first MEMS device 100, the capacitance (C) between the movable electrode 150 and the fixed electrode 120 varies according to the difference between the external pressure and internal pressure of the thin-film dome 160. Thus, the external pressure can be detected based on the capacitance value between the movable electrode 150 and the fixed electrode 120. The variation characteristics in capacitance due to pressure are wide as a pressure range of 10 to 500 kPa as indicated by a solid line A in FIG. 10.

On the other hand, in the second MEMS device 200, the principle is similar to that of the first embodiment. That is, the movable electrode 150 is driven by application of a direct-current voltage, and during the movable electrode 150 being driven, the time-elapse characteristics of the distance between the electrodes is monitored. Here, the mechanical characteristics (Q-value) of the movable electrode 150 is obtained, and based on the Q-value, the external pressure is detected. The variation characteristics of the Q value are wide as a pressure range of 0.1 to 10 kPa as indicated by a solid line B in FIG. 10. In this manner, with the first MEMS device 100 and the second MEMS device 200, it is possible to sense a pressure range from, for example, 0.1 kPa to 600 kPa.

Further, in the first MEMS device 100, the movable electrode 150 is jointed to the thin-film dome 160 via the anchor 165. In this state, when a pressure is applied to the thin-film dome 160, the thin-film dome 160 deforms, but the movable electrode 150 does not deform and moves downwards along a parallel path. Therefore, the distance between the movable electrode 150 and the fixed electrode 120 does not very regardless of a location with respect to the center of the thin-film dome 160. On the other hand, in the case where the movable electrode 150 is connected in its entirety to the inner upper surface of the thin-film dome 160, if the thin-film dome 160 deforms due to pressure, the movable electrode 150 also deforms. Therefore, in this case, the distance between the movable electrode 150 and the fixed electrode 120 becomes larger as the location is further away from the center of the thin-film dome 160.

When the thin-film dome 160 deforms with the same pressure, the average distance between the movable electrode 150 and the fixed electrode 120 becomes shorter in the case where the movable electrode 150 is jointed to the central portion of the thin-film dome 160 via the anchor 165. In this manner, it is possible to provide an MEMS device capable of obtaining a larger change in capacitance for the same pressure. Thus, the detection accuracy of the MEMS device can be improved in this way as well.

Further, the through-hole 260a for releasing the inside of the thin-film dome to the atmosphere, is provided in the projecting portion of the thin-film dome 160. With this structure, if contaminant enters from the through-hole 260a, the contaminant does not substantially affect the movement of the movable electrode 250.

As described above, according to this embodiment, a sensor with a wide pressure range can be realized by combining a capacitance-type pressure sensor (displacement detection type) of the first MEMS device 100 airtightly sealed and a pressure sensor using mechanical characteristics (Q-value measurement type) of the second MEMS device 200 not airtightly sealed. Further, the two MEMS devices 100 and 200 can be formed at the same time using a process and step substantially the same as those of the conventional technique. Thus, it is possible to widen the range of the pressure sensor without increasing the cost.

Moreover, in the first MEMS device 100, the movable electrode 150 is connected to the thin-film dome 160 via the anchor 165. With this structure, it is possible to realize a MEMS device capable of obtaining a larger change in capacitance for the same pressure. Thus, the detection accuracy of the MEMS device can be improved.

Further, in the second MEMS device 200, the thin-film dome 260 comprises a part projecting therefrom, in which the through-hole 260a is made. With this structure, this embodiment achieves the following advantages. That is, the inside of the thin-film dome 260 can be released to the atmosphere without causing an increase in size of the thin-film dome 260, and further obstructive factors to the movement of the movable electrode 50 can be suppressed.

### Modified Example

The embodiments are not limited to those described above. The location of the opening in the thin-film dome is not limited to those of the embodiments provided above. Or it is not even essential to form the projecting portion, but an opening may be made in a portion of the thin-film dome. However, when an opening is located above the movable electrode, the movable electrode may be contaminated by contaminants entering the dome. In order to avoid this, the opening should preferably be provided on an outer side with respect to the section above the movable electrode. Alternatively, it is also possible to make a through-hole in the substrate in place of the thin-film dome.

In the embodiments provided above, the movable electrode and the spring members are formed integrally as one unit, but these members may be formed of conductive films of materials different from each other. For example, an anchor may be fixed on a wire, and an end of a spring member, which is a separate member from a movable electrode, may be connected to an end of the movable electrode, whereas the other end of the spring member may be connected to the anchor.

Further, the measuring circuit for measuring mechanical characteristics of the movable electrode is not limited to a CMOS consolidated circuit formed in the substrate, but may be a circuit provided outside.

Furthermore, the material for the movable electrode is not limited to Al or AlCu alloy, but it can be selected from various types of conductive materials. Further, the embodiments use an Al electrode as the movable electrode, and take the form of a wafer level package structure, but they are not limited to such a structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pressure sensor comprising:
a fixed electrode fixed on a substrate;
a movable electrode provided above the fixed electrode, the movable electrode being movable in vertical directions; and
a thin-film structure of a dome shape, forming, together with the substrate, a cavity to accommodate the fixed electrode and the movable electrode, the thin-film structure comprising a communicating hole to communicate the cavity with an outside of the thin-film structure.

2. The sensor of claim 1, further comprising:
a measuring mechanism to apply a voltage between the fixed electrode and the movable electrode and measure mechanical displacement of the movable electrode.

3. The sensor of claim 1, further comprising:
a spring member integrated with the movable electrode.

4. The sensor of claim 1, wherein
the communication hole is made in a part of the thin-film structure, which is on an outer side with respect to the movable electrode.

5. The sensor of claim 1, wherein
the communication hole is made in a projecting portion outwardly projecting from the thin-film structure.

6. The sensor of claim 1, further comprising:
a wire on the substrate on an outer side of the fixed electrode,
wherein an end of the movable electrode is connected to the wire via a spring member.

7. The sensor of claim 1, wherein
the thin-film structure comprises a first insulating film comprising openings, a resin film formed on the first insulating film to block the openings, and a second insulating film formed on the resin film.

8. The sensor of claim 2, wherein
the measuring mechanism is configured to measure a change in oscillation along with time of the movable electrode when the movable electrode is driven by a direct-current voltage.

9. The sensor of claim 2, wherein
the measuring mechanism is configured to measure a change in displacement of the movable electrode when a high-frequency voltage is applied to the movable electrode.

10. A pressure sensor comprising:
a substrate;
a first MEMS device provided on the substrate; and
a second MEMS device provided on the substrate;
wherein
the first MEMS device comprises a first fixed electrode fixed on the substrate, a first movable electrode provided above the first fixed electrode to be movable in vertical directions, and a first thin-film structure of a dome shape, forming, together with the substrate, a first cavity to accommodate the first fixed electrode and the first movable electrode, and comprising a part connected to the first movable electrode,
the second MEMS device comprises a second fixed electrode fixed on the substrate, a second movable electrode provided above the second fixed electrode to be movable in vertical directions, a second thin-film structure of a dome shape, forming, together with the substrate, a second cavity to accommodate the second fixed electrode and the second movable electrode, and a communicating hole to communicate the second cavity in the second thin-film structure to air outside the second thin-film structure, and
the first MEMS device is configured to measure a capacitance between the first fixed electrode and the first movable electrode, and the second MEMS device is configured to measure mechanical characteristics of the second movable electrode.

11. The sensor of claim 10, wherein
a central portion of the first thin-film structure is connected to the first movable electrode by an anchor in the first MEMS device, and
the second thin-film structure is unconnected with the second movable electrode in the second MEMS device.

12. The sensor of claim 10, wherein
the communication hole is made in a part of the second thin-film structure, which is on an outer side with respect to the second movable electrode.

13. The sensor of claim 10, wherein
the communication hole is made in a projecting portion outwardly projecting from the second thin-film structure.

14. The sensor of claim 10, wherein
the second MEMS device is configured to measure a change in oscillation along with time of the second movable electrode when the second movable electrode is driven by a direct-current voltage.

15. The sensor of claim 10, wherein
the second MEMS device is configured to measure a change in displacement of the second movable electrode when a high-frequency voltage is applied to the second movable electrode.

16. The sensor of claim 10, wherein
the first MEMS device is configured to measure a pressure of a high-pressure region with the capacitance, and the second MEMS device is configured to measure a pressure of a low-pressure region with the mechanical characteristics.

17. A method of manufacturing a pressure sensor, comprising:
forming a fixed electrode on a substrate;
forming a first sacrificial layer to cover the fixed electrode;
forming a movable electrode on the first sacrificial layer;
forming a second sacrificial layer to cover the movable electrode;
forming a first cap layer to cover the second sacrificial layer;
forming an opening in the first cap layer;
removing the first and second sacrificial layers through the opening;
forming an organic film to block the opening of the cap layer;
forming a second cap layer to cover the first cap layer and the organic film, thereby forming, together with the substrate, a thin-film structure of a dome shape comprising a cavity to accommodate the fixed electrode and the movable electrode; and
forming a communicating hole through the first and second cap layers, to communicate the cavity in the thin-film structure with an outside of the thin-film structure.
